(19) United States
(12) Patent Application Publication
(10) Pub. No.: US 2013/0021671 A1
(43) Pub. Date: Jan. 24, 2013

(54) LIGHT GUIDE PLATE

(71) Applicant: Michael LEE, Taichung City (TW)

(72) Inventor: Michael LEE, Taichung City (TW)

(21) Appl. No.: 13/214,484

(22) Filed: Aug. 22, 2011

(30) Foreign Application Priority Data
Jul. 18, 2011 (TW) 100125314

(51) Int. Cl. G02B 5/02

(52) U.S. Cl. 359/599

(57) ABSTRACT

A light guide plate for use in a backlight module of a touch panel is disclosed. The light guide plate includes a transparent plate, and first and second adhesive layers disposed on two opposite surfaces of the transparent plate respectively. A plurality of refractive regions are spacedly arranged on at least one of the two opposite surfaces of the transparent plate. As a result, it is convenient to attach the light guide plate to any desired location and the light refracted from the light guide plate may have uniform brightness

### BACKGROUND OF THE INVENTION

1. Field of the Invention

The present invention relates generally to a light guide plate and more particularly, to a light guide plate having refractive regions that can refract light having uniform brightness.

2. Description of the Related Art

In recent years, various kinds of electronic products are constantly developed. Among those electronic products, a touch panel product, such as personal digital assistant (PDA), smartphone, tablet computer, etc., attracts more attentions and has wide application. Taking the smartphone for example, a user can simply touch the screen to perform tasks such as zooming in or out images or pages, or access files; therefore, merely a small number of function keys are disposed on the periphery of the touch panel for allowing the user to conveniently turn on/off the smartphone.

Generally speaking, a touch panel includes a touchable control surface and an untouchable surface opposite to the touchable control surface. Patterns of the function keys are printed on the untouchable surface and a light guide plate is disposed behind the touch panel in a way that the light extracting surface of the light guide plate faces the patterns. At least one light source is disposed at one side or two opposite sides of the light guide plate, such that the light emitted from the light source is guided to the light extracting surface to light the aforesaid function keys.

If only one light source is used at one side of the light guide plate, the light extracted out from the light extracting surface at a location close to the light source will be brighter than that at a location far away from the light source, resulting in that the brightness of the light extracted from the light guide plate is non-uniform. However, if two light sources are used in order to enhance the uniformity of the brightness of the light extracted from the light guide plate, the electricity consumption will be undesirably increased.

In addition, an adhesive must be applied on the conventional light guide plate before the light guide plate is going to be attached on a target such as the above-mentioned untouchable surface of the touch panel. This additional procedure makes the work of assembling the conventional light guide plate with the target inconvenient.

### SUMMARY OF THE INVENTION

The present invention has been accomplished in view of the above-noted circumstances. It is therefore the primary object of the present invention to provide a light guide plate that can refract light having uniform brightness.

The secondary object of the present invention is to provide a light guide plate that can be conveniently adhered on a target.

To achieve the above-mentioned objects, a light guide plate provided by the present invention has a light extracting surface and a bottom surface opposite to the light extracting surface. The light guide plate mainly comprises a transparent plate having a first surface corresponding to the light extracting surface and a second surface opposite to the first surface and corresponding to the bottom surface, a first adhesive layer, and a second adhesive layer. At lease one of the first surface and the second surface is provided thereon with a plurality of refractive regions spacedly arranged, and the first and second adhesive layers are disposed on the first and second surfaces of the transparent plate respectively. Because the light guide plate of the present invention has spacedly arranged refractive regions, the light refracted from the light guide plate may have uniform brightness. Besides, the light guide plate of the present invention has the first and second adhesive layers, such that it can be attached on any desired location conveniently.

The light guide plate of the present invention may further comprise a first release paper and a second release paper. The first adhesive layer is located between the first release paper and the transparent plate, and the second adhesive layer is located between the second release paper and the transparent plate, such that the stickiness of the first and second adhesive layers can be maintained.

The light guide plate of the present invention may further comprise a reflective layer disposed on the second adhesive layer, and a third adhesive layer disposed between the reflective layer and the second release paper. As a result, the light transmitted from the second surface of the transparent plate can be reflected back into the transparent plate by the reflective layer to enhance the usage efficiency of the light.

The light guide plate of the present invention may further comprise a diffusion layer disposed on the first adhesive layer, and a fourth adhesive layer disposed between the diffusion layer and the first release paper. As a result, the light transmitted from the light extracting surface of the light guide plate can be scattered by the diffusion layer and then become more uniform and soft.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a light guide plate according to a preferred embodiment of the present invention;

FIG. 2 is a schematic diagram, showing that the light guide plate according to the preferred embodiment has a laminated structure;

FIG. 3 is similar to FIG. 2 but showing another laminated structure of the light guide plate according to the preferred embodiment;

FIG. 4 is similar to FIG. 2 but showing still another laminated structure of the light guide plate according to the preferred embodiment;

FIG. 5 is similar to FIG. 2 but showing still another laminated structure of the light guide plate according to the preferred embodiment; and

FIG. 6 is a perspective view of the light guide plate according to the preferred embodiment of the present invention, showing another pattern of the refractive region.

### DETAILED DESCRIPTION OF THE INVENTION

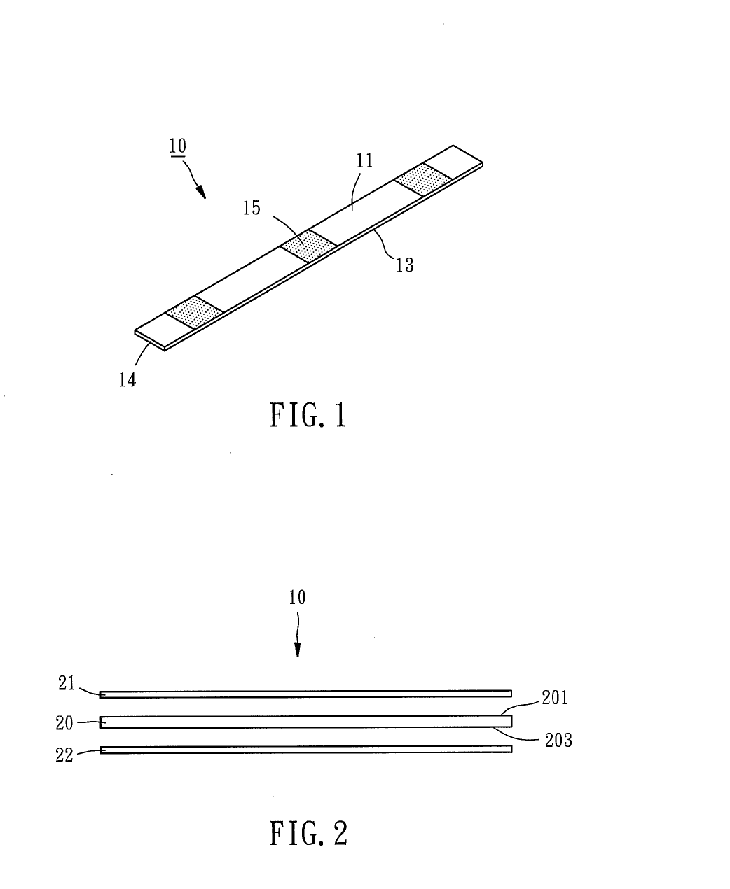

It should be noted that the same reference numeral used in the following embodiment and appendix drawings refers to identical or similar element or structure. As shown in FIG. 1, a light guide plate 10 provided by a preferred embodiment of the present invention is shaped like a rectangular strip, which comprises a light extracting surface 11, a bottom surface 13 opposite to the light extracting surface 11, a light incident surface 14 located at a side thereof, and a plurality of refractive regions 15 spacedly arranged.

As shown in FIG. 2, the light guide plate 10 mainly includes a transparent plate 20, a first adhesive layer 21, and a second adhesive layer 22. The material of the transparent plate 20 can be, but not limited to, polycarbonate (PC), polymethyl methacrylate (PMMA), polyethylene terephthalate (PET), etc. The first and second adhesive layers 21, 22 are preferred made of optical clear adhesive (OCA) in solid state or liquid state, such as acrylic adhesive. The transparent plate 20 includes a first surface 201 and a second surface 203. The plurality of the refractive regions 15 are disposed on the first surface 201 and/or the second surface 203 of the transparent plate 20, and in the preferred embodiment, the refractive regions 15 are disposed on the first surface 201 and has a pattern composed of several dots, as shown in FIG. 1. Referring to FIG. 2 again, the first and second adhesive layers 21, 22 are disposed on the first and second surface 201, 203 of the transparent 20 respectively. As a result, the light entering the transparent plate 20 will be reflected or refracted by the dots of the refractive regions 15, and finally extracted out of the light guide plate from the light extracting surface 11 of the light guide plate 10 with uniform brightness. By means of providing a signal light source (not shown) adjacent to the light incident surface 14 of the light guide plate 10, the light having uniform brightness can be provided through the light guide plate 10 of the present invention. In addition, because the light guide plate 10 of the present invention has the first and second adhesive layers 21, 22, it can be adhesively attached to any desired location conveniently.

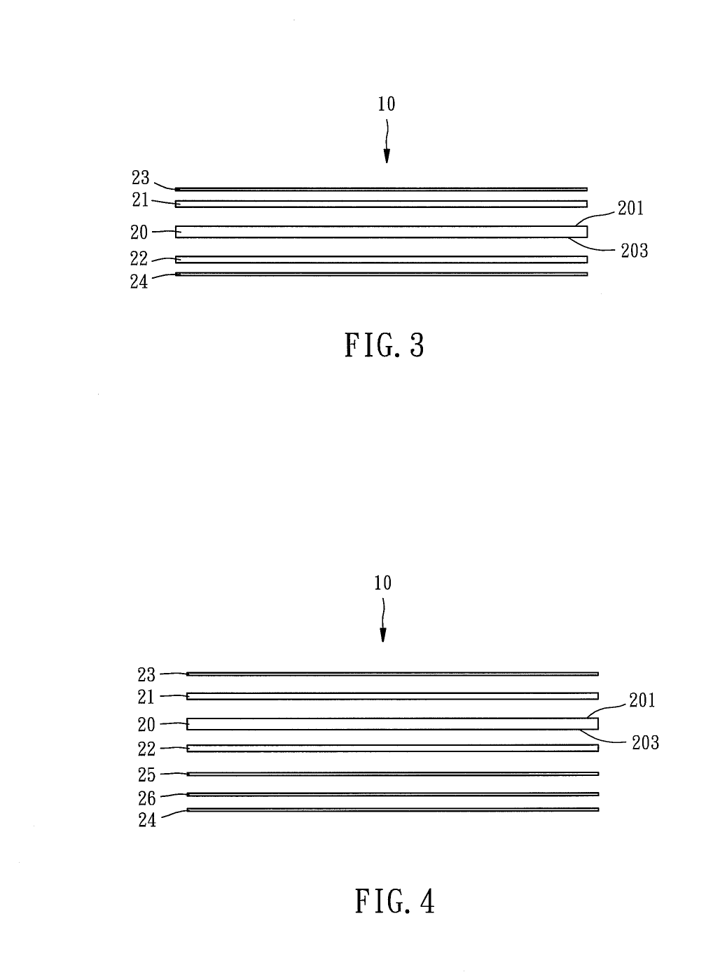

The light guide plate 10 of the present invention may have alternate structures as shown in FIGS. 3-5 respectively according to the actual need.

More specifically, as shown in FIG. 3, the light guide plate 10 further comprises a first release paper 23 and a second release paper 24. The first release paper 23 is disposed on the first adhesive layer 21 and the second release paper 24 is disposed on the second adhesive layer 22, such that the first adhesive layer 21 is located between the transparent plate 20 and the first release paper 23, and the second adhesive layer 22 is located between the transparent plate 20 and the second release paper 24. The first and second release papers 23, 24 can protect the first and second adhesive layers 21, 22 from being exposed to the air so as to maintain the stickiness of the first and second adhesive layers 21, 22.

Besides, as shown in FIG. 4, the light guide plate 10 further comprises a reflective layer 25 and a third adhesive layer 26. The reflective layer 25 is disposed on the second adhesive layer 22 and the third adhesive layer 26 is disposed on the reflective layer 25, such that the third adhesive layer 26 is located between the reflective layer 25 and the second release paper 24. As a result, the light transmitted from the second surface 203 of the transparent plate 20 can be reflected back into the transparent plate 20 by the reflective layer 25 to enhance the usage efficiency of the light.

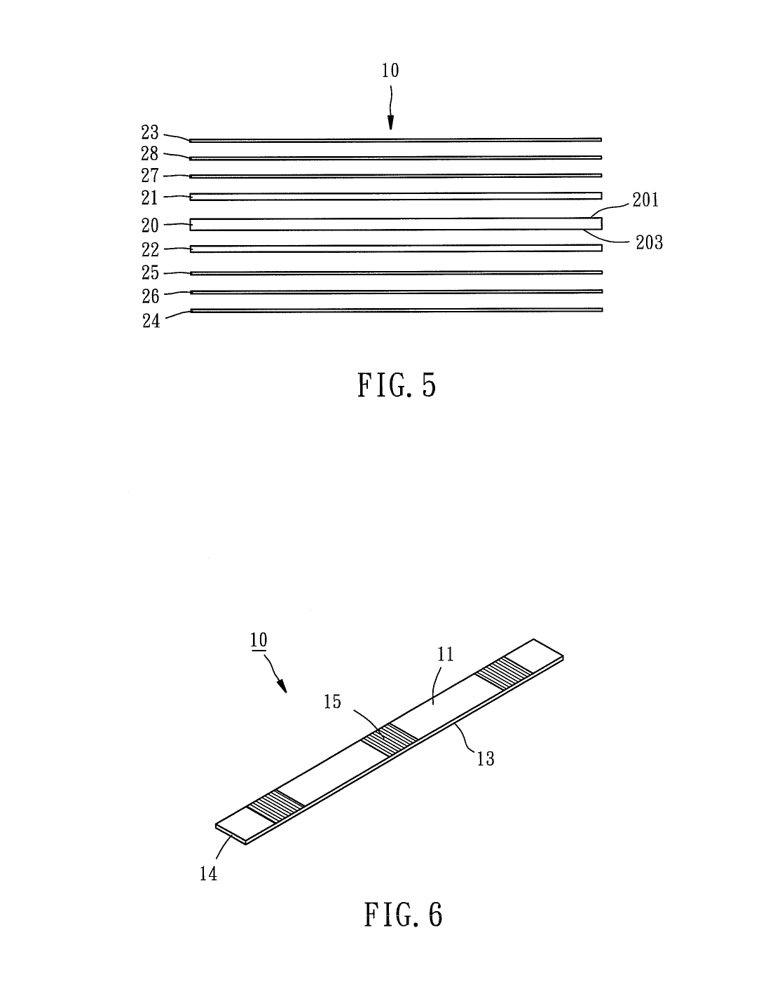

As shown in FIG. 5, the light guide plate 10 further comprises a diffusion layer 27 and a fourth adhesive layer 28. The diffusion layer 27 is disposed on the first adhesive layer 21 and the fourth adhesive layer 28 is disposed on the diffusion layer 27, such that the fourth adhesive layer 28 is located between the diffusion layer 27 and the first release paper 23. As a result, the light transmitted from the light extracting surface 11 of the light guide plate 10 can be scattered by the diffusion layer 27 and then become more uniform and soft.

The third and fourth adhesive layers 26, 28 are preferred made of OCA which is identical to the above-mentioned one from which the first and second adhesive layers 21, 22 are made.

It should be understood that anyone skilled in the art can decide whether or not the reflective layer 25 or the diffusion layer 27 is provided according to the actual need. Therefore, the reflective layer 25 and the diffusion layer 27 can exist simultaneously or individually in the present invention. Further, the pattern of the refractive region 15 is not limited to the above-mentioned dots, any pattern that can enhance the reflection and the refraction of the light is applicable. For example, the pattern of the refractive region 15 may be formed of cuts, as shown in FIG. 6, or textures.

In conclusion, because the light guide plate of the present invention has a plurality of refractive regions spacedly arranged, the light entering the light guide plate can be extracted from the light guide plate with uniform brightness. In this way, by means of cooperating a single light source, such as a light emitting diode (LED), with the light guide plate of the present invention, the light having uniform brightness can be provided with less electricity consumption. Besides, because the light guide plate of the present invention has adhesive layers, it can be adhesively attached to any desired location conveniently. In addition, the arrangement of the optional reflective and/or diffusion layers can enhance the light-guiding efficiency of the light guide plate of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A light guide plate comprising:
a transparent plate having a first surface, a second surface opposite to the first surface, and a plurality of refractive regions spacedly arranged on at least one of the first and second surfaces;
a first adhesive layer disposed on the first surface of the transparent plate; and
a second adhesive layer disposed on the second surface of the transparent plate.

2. The light guide plate as claimed in claim 1, further comprising a first release paper and a second release paper; wherein the first adhesive layer is located between the transparent plate and the first release paper, and the second adhesive layer is located between the transparent plate and the second release paper.

3. The light guide plate as claimed in claim 2, further comprising a reflective layer disposed on the second adhesive layer, and a third adhesive layer disposed between the reflective layer and the second release paper.

4. The light guide plate as claimed in claim 3, further comprising a diffusion layer disposed on the first adhesive layer, and a fourth adhesive layer disposed between the diffusion layer and the first release layer.

5. The light guide plate as claimed in claim 2, further comprising a diffusion layer disposed on the first adhesive layer, and a fourth adhesive layer disposed between the diffusion layer and the first release paper.

6. The light guide plate as claimed in claim 1, wherein the pattern of the refractive region is composed of a plurality of dots, cuts, or textures.
